(19) United States
(12) Patent Application Publication
(10) Pub. No.: US 2023/0117887 A1
(43) Pub. Date: Apr. 20, 2023

(54) COATING DEVICE HAVING A STABLE SHEET GUIDANCE

(71) Applicant: BATTRION AG, Dübendorf (CH)

(72) Inventors: Martin EBNER, Küsnacht (CH); Deniz BOZYIGIT, Zürich (CH); Max KORY, Zürich (CH)

(73) Assignee: BATTRION AG, Dübendorf (CH)

(21) Appl. No.: 18/057,858

(22) Filed: Nov. 22, 2022

Related U.S. Application Data
(63) Continuation of application No. PCT/EP2022/056012, filed on Mar. 9, 2022.

(30) Foreign Application Priority Data
Mar. 9, 2021 (DE) 10 2021 105 658.6

(51) Int. Cl. H01M 4/04; H01M 4/1393; B05C 13/02; B05C 19/00

(52) U.S. Cl. CPC H01M 4/0404; H01M 4/1393; B05C 13/02; B05C 19/008

(57) ABSTRACT

A coating device for coating a carrier with a coating is proposed, comprising a transport device for transporting the carrier during the coating process for coating the carrier on at least one side of the carrier and for transportation at least after the application of the paste to one side, and an aligning device. For particularly stable sheet guidance, the transport device comprises a supporting device for the positionally stable supporting of the carrier with regard to the direction perpendicular to the transport surface, in which the carrier lies during transport, and/or perpendicular to the transport direction, which is configured to form a mechanical constraint for the range of movement of the carrier perpendicular to the surface in the direction of the uncoated side of the carrier, in order to counteract a change in the position with regard to the direction perpendicular to the surface.

### CROSS REFERENCE TO RELATED APPLICATIONS

This application is a continuation of International Application No. PCT/EP2022/056012 filed Mar. 9, 2022, which designated the United States, and claims the benefit under 35 USC § 119(a)-(d) of German Application No. 10 2021 105 658.6 filed Mar. 9, 2021, the entireties of which are incorporated herein by reference.

### FIELD OF THE INVENTION

The present invention relates to a coating apparatus for coating at least one side of a carrier with a paste.

### BACKGROUND OF THE INVENTION

A production process for such a coating of a carrier foil with a paste is known, for example, from the prior art from WO 2018/047054 A1 and is explained using the example of the manufacture of a negative electrode for lithium ion batteries. The carrier is in the form of a foil web, which is transported through the corresponding manufacturing/coating installation by way of rollers. In that case, the paste also contains graphite particles which can be oriented in a magnetic field. However, the transport has to be carried out very precisely, this is because, in order to obtain a precisely controllable orientation of the graphite particles, the carrier has to be guided in a precisely defined manner through the magnetic field.

In JP 2020053278 A, reference is made to the problem that, when using drying blowers to dry coatings, the carrier can sag as a result of the air flow. In order to compensate for this, a magnetic material is added to the electrode material, more precisely the coating on the carrier, and a permanent magnet is arranged in the vicinity of the carrier, in order to compensate for the sagging.

### SUMMARY OF THE INVENTION

It is an object of the present invention to provide a coating apparatus which permits a more precise manufacturing operation with more precise positioning of the carrier.

The coating apparatus according to the present invention provides a transporting apparatus, by means of which the carrier foil to be coated is guided through the installation. The carrier foil itself is not a fixed constituent of the coating apparatus according to the present invention.

In the nomenclature used here, the carrier in turn comprises a foil as basic material and the coating applied to the foil. For the production of negative electrodes for lithium ion batteries, for example, use is made of copper foil, which is present in long webs. However, it has been proven that, in conventional methods according to the prior art, the transport of, in particular, long foil webs in relation to the force field or magnetic field is insufficiently precise and has hitherto regularly caused problems.

In addition, in the case of a coating, there are generally further requirements on the manufacturing process: As coating, by way of example, a paste composed of soft to liquid material is applied and subsequently dried. During the drying, the paste volume may shrink due to evaporation of constituents of the paste. The adhesion to the foil may cause the carrier overall to deform, bulge, wrinkle or crease. Furthermore, during the heating, which is employed for drying the paste, the carrier may expand or contract.

For example, it should be expected in the manufacture of lithium ion batteries that the copper foil used will expand upon heating, whereas a paste applied thereto contracts. The overall complex of the carrier, which comprises the foil and the paste, curves in that case, similar to a heating bimetallic strip through which current flows.

This can in turn lead to the carrier overall deforming, bulging, wrinkling or creasing. These effects have hitherto caused fundamental problems in the mounting and positioning and thus also in the transport and the manufacture, in particular, in the precise positioning, of the carrier in a force field.

The paste with which the carrier foil is, for example, coated may contain particles in platelet form, in which, for a majority of the particles, an ellipsoid approximating to the respective particle shape has two axes of similar length and one distinctly shorter axis.

The paste with which the carrier foil is, for example, coated may contain spherical particles, in which, for a majority of the particles, an ellipsoid approximating to the respective particle shape has three axes of similar length.

The paste with which the carrier foil is, for example, coated may contain acicular particles, in which, for a majority of the particles, an ellipsoid approximating to the respective particle shape has one long axis and two distinctly shorter axes.

If the paste with which the carrier foil is coated contains particles such as carbon-based particles, in particular, graphite particles, in particular, particles in platelet form, the uniform orientation of the particles can indeed in principle influence the distortion due to volume reduction during drying, however the orientation is prescribed by the desired production result and cannot be governed solely by a potential distortion. If possible, the coating may also comprise a material having thermoresponsive properties, but even these properties generally contribute only partially to the avoidance of distortions.

It is, for example, possible for particles to be oriented in the paste under the influence of a force field. Graphite particles can be oriented, for example, in a magnetic field, in particular, a temporal and/or spatial alternating magnetic field. If there are particles in the paste that are intended to be oriented, this process is advantageously carried out prior to and/or during the drying, since the particles in a completely dried and solidified mass of paste surrounding them are usually barely still able to move mechanically. The orientation of the particles can be performed, in part, at the same time as the drying process, so that the orientation of the particles is not completely or partially lost again during the drying, for example, due to an air flow or under the influence of shrinkage of the paste volume. It is also conceivable for the deformation which occurs during drying and shrinkage of the paste to be counteracted by active forming of the carrier. However, in order for foil to not lift out of the mounting arrangement in the case of such deformation, it is alternatively possible to employ the bearing apparatus according to the present invention which permits mounting in multiple directions, where appropriate in a contactless manner.

Apart from a paste which comprises a soft or liquid mass comprising particles as an essential component, it is also possible for dry coating with a powder to be effected. Depending on the application, the particles may also be oriented in the dry coating in a force field. It is also possible for the present invention to be used with this material.

The coating apparatus according to the present invention provides reliable and stable mounting, even if the carrier has a sensitive coating and a precise positioning is desired.

Correspondingly, the coating apparatus according to the present invention is distinguished in that the transporting apparatus comprises a bearing apparatus for the positionally stable mounting of the carrier in relation to a direction perpendicular to the transport plane, in which the carrier lies during transport, the bearing apparatus being able to be used to exert a force perpendicular to the transport surface. The bearing apparatus is fundamentally able to engage, with or without contact, with uncoated locations, on which no coating is present, or with coated locations. The bearing apparatus thus represents a mechanical constraint for the movement range perpendicular to the transport plane or to the surface of the carrier.

During the production process, stable mounting in the transport plane is not only advantageous for being able to apply the paste precisely during the coating but also for exposing the carrier to a force field in a defined manner. In particular, it is advantageous for positioning the carrier in the force field in a precisely defined manner, for example, for orienting it precisely in relation to the apparatus generating the force field and for positioning it at a precisely defined distance in relation to the apparatus generating the force field. In general, use is typically made of permanent magnets for generating a magnetic field, which is why it is particularly important that the carrier is positioned at the predetermined, well-defined distance from the permanent magnets, so that the particles to be oriented are exposed to the intended field strength required for orienting the particles. Such stable mounting can be obtained by way of the coating apparatus according to the present invention. In particular, the distance of the carrier from the magnets has to be precisely defined over the entire surface on which the magnetic field acts on the carrier. With respect to its mounting arrangement, the coating apparatus according to the present invention can also dispense with convex foil guidance, which is conventionally used in the prior art but can be significantly more complex to implement.

In an embodiment variant, the distance between the foil and the magnet is preferably between 0 mm-200 mm, preferably between 0 mm-20 mm, particularly preferably 1 mm-4 mm.

In refinements of the present invention, use can, for example, be made of the following bearing apparatuses or combinations of bearing apparatuses.

The carrier may rest on one or more roller bearings. The roller bearings provide a mechanical constraint so that the carrier does not sag in the direction of gravitational force. They have the advantage that they can co-rotate with the translational movement of the carrier, thus also bring about only small friction forces, which also consequently might not influence the carrier (for instance, by abrasion, electrostatic charging or the like).

Instead, grinding bearings are also possible, which do not co-rotate upon contact with the carrier but rather remain rotationally fixed. In general, areal grinding bearings are not usable since they have a large contact surface in contact with the carrier and thus lead to high friction forces. It is generally possible to use thin wires or plastics threads which are stretched transversely or at an angle with respect to the transporting direction. The carrier rests on the wire or thread and slides over it. On account of the extremely small contact surface, usually only small friction forces occur between carrier and thread or wire. Such mounting can usually be implemented cost-effectively, in a space-saving manner with a small structural height and also without relatively great technical effort.

There are various possibilities for the arrangement or the combination of bearings: roller bearings or grinding bearings are generally used in the case of contact with solid surfaces. To reduce the friction, provision may also be made of a liquid cushion, such that the carrier slides over this cushion.

With respect to surfaces composed of soft material or liquid coatings, it is in turn advantageous to use contactless bearings. In the case of a gas bearing or air bearing, for example, a gas flow, advantageously an air flow, is generated on a surface. The carrier can then slide on this gas cushion. The friction forces are regularly negligibly low. Nevertheless, a gas bearing should be dimensioned such that it does not hinder the drying operation, especially if it is arranged on the coating side. It is particularly advantageous for a gas bearing to be designed such that it can be arranged above the magnets in an areal manner, and has a small thickness, advantageously between 1 mm-4 mm. In this configuration, the magnetic field penetrates the gas bearing and acts on the carrier. This allows precise mounting of the foil parallel to the magnets.

It is advantageously also possible to use a vacuum bearing, which provides negative pressure, for example, by way of a vacuum pump or a blower. The vacuum bearing suctions the carrier and thus exerts a force action on it. This arrangement can also be used to press the carrier against another bearing.

In addition, electromagnetic bearings such as eddy-current bearings or electrostatic bearings are also conceivable, which permit similarly low friction forces as gas bearings. Nevertheless, it is necessary for the material to be mounted to have corresponding properties, for example, allowing an electrostatic charge or the generation of eddy currents.

Contactless bearings such as gas bearings or electromagnetic bearings can especially be used on the coating side. These can effectively prevent the carrier from bending or bulging excessively perpendicular to the transport plane, but without contacting or damaging the soft or partially liquid coating in doing so. At the same time, the gas bearings according to the refinement of the present invention make it possible for the access to the foil, that is to say during the drying operation, for example, to not be hindered.

Overall, it is advantageous for all the bearings to be oriented such that the straightness of the foil perpendicular to the foil transporting direction is ensured, in order to avoid any bulging, creasing or wrinkling of the foil, wherein contactless bearings can permit a certain amount of play in a lateral direction.

The following bearing arrangements are considered as a starting point. It is fundamentally possible for conventional rollers, via which the carrier band is guided, to then each be arranged between the respective magnets in the transporting direction, so that the field lines are not disturbed by the rollers. However, rollers require a comparatively large amount of space. On account of the one-sided mounting, the foil may lift off from the rollers. Lifting-off of the foils during the orienting operation increases the distance from the magnets, that is to say the particles may be oriented only to an insufficient extent.

In order to obtain the precise distance between the foil and the magnet, spacers, which rest on the magnets, may be used. However, such mounting fundamentally also constitutes one-sided mounting, that is to say lifting-off of the foil is still possible. It only prevents the distance between foil and magnet from becoming too small. In addition, this conventional mounting is associated with difficulties, because a spacer constitutes a grinding bearing, and scratches in the foil can occur due to the friction. The process stability may no longer be ensured.

According to one exemplary embodiment, gas bearings, such as air bearings, can then be used. A contactless air bearing can be used, in particular, on the coated side, such that, irrespective of which bearing is used on the opposite side (for example, a contacting roller or grinding bearing or a contactless gas bearing), there is a double-sided mounting arrangement, which engages with the opposite sides.

If the individual bearings are connected in series (in the transporting direction), the distance between adjacent bearings may, in principle, be between 1 cm and 8 m, preferably 1 cm-50 cm, depending on which bearings are used.

In order for the air bearing arranged on the coating side, for example, the upper air bearing, to not disrupt the drying process and for there to not be poor access for the drying, a vacuum bearing for exerting a pressing force may be provided. This vacuum bearing can be arranged on the same side of the carrier as the other bearings, since it suctions the foil, that is to say acts in the opposite direction to the force direction of the other bearings. The vacuum bearing can preferably be designed with a vacuum pump.

The coating apparatus serves for the final completion of the coating, such that the coating apparatus also comprises, according to the present invention, an orienting apparatus in order to be able to orient the particles in the paste. The orienting apparatus generates the force field, under the influence of which the particles are oriented. In the case of graphite particles of platelet form in flake form or elongate form, use can be made of temporally or spatially alternating magnetic fields. In general, permanent magnets are essentially arranged in stacks and oriented such that the orientation of their magnetic fields spatially varies, with the result that the carrier moving through the fields is subjected to a temporally alternating magnetic field in relation to a point that is fixed relative to the carrier. In order to obtain coated carriers of constant quality, a stable positioning of the carrier, which is made possible by a coating apparatus according to the present invention, is advantageous particularly when passing through the magnetic fields.

The bearing apparatus advantageously mounts the carrier perpendicular to the transport plane in a stable position. In an advantageous exemplary embodiment of the present invention, the bearing apparatus is thus configured for at least two-sided or for multi-sided mounting of the carrier. With regard to the distance from elements generating a magnetic field, the bearing elements may, for example, be arranged in an opposite manner above and below the transport plane or the carrier. The bearings may also engage in a U-shaped manner around the carrier in the peripheral region and thus form a three-sided bearing.

Two or more bearings may be connected in series along the transport path, in order to obtain particularly stable mounting over the corresponding region. The bearings may be arranged in an opposite manner at the individual locations along the transport path or directly in series at various locations. In this way, in spite of the length of the foil web, sagging of the latter is prevented or reduced.

In a preferred embodiment of the present invention, at least two gas bearings are connected in series, wherein a vacuum bearing for exerting a pressing force perpendicular to the transporting direction is provided on the same side as where the gas bearings are located. In this way, the stability can be increased, in particular.

The carrier may be distorted during drying of the paste, which generally leads to a disruptive bulge perpendicular to the transport plane. With regard to such a bulge, it may be advantageous to use, for example, a grinding bearing which restores the shape of the carrier or of the foil.

A bearing force on the coated side can fundamentally also be brought about by convex foil guidance. The foil then passes along a longer path than in a straight line; the guidance of the foil with a constant change in direction on the circular arc-shaped path section also has the effect that the carrier foil receives a certain pressing action. However, especially when orientation is also intended to be effected at the same time on this transport path section, it is necessary for a convex force field or magnet surface to be produced there, which is difficult in technical terms. The convex guidance can also be effected only within a determined scope, since the coating apparatus generally permits only a determined angular range in terms of geometry.

Nevertheless, in one embodiment of the present invention, it is also possible for convex foil guidance to be used in combination with at least one air bearing. For the drying process, all the bearings may be arranged on one side, such that, for example, the coated side is accessible to a drying process.

### BRIEF DESCRIPTION OF THE DRAWINGS

Exemplary embodiments of the present invention are illustrated in the drawings and are explained in more detail below with further details and advantages being given.

FIG. 1 shows differently coated carriers;

FIG. 2 shows a schematic illustration of a roller bearing in a coating apparatus;

FIG. 3 shows a schematic illustration of a grinding bearing in a coating apparatus according to the present invention;

FIG. 4 shows a schematic illustration of an air bearing in a coating apparatus according to the present invention;

FIG. 5 shows a schematic illustration of a combination of air bearing and vacuum bearing according to the present invention;

FIG. 6 shows a schematic illustration of a double-sided air bearing according to the present invention;

FIGS. 7 and 8 each show schematic illustrations of an air bearing with convex foil guidance according to the present invention and with differing embodiments of the permanent magnets generating the force field;

FIG. 9 shows a schematic illustration of a coating apparatus according to the present invention; and

FIG. 10 shows an illustration of an air bearing for use according to the present invention.

### DETAILED DESCRIPTION OF THE INVENTION

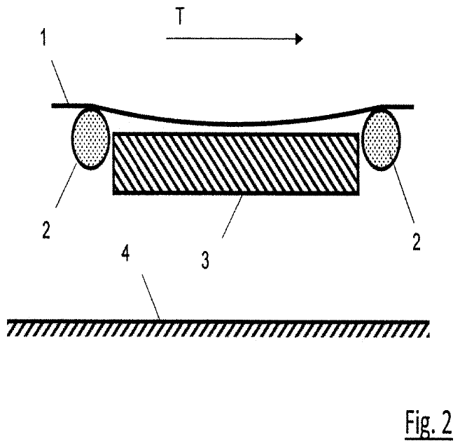

FIGS. 2-4 each show bearings which act on one side.

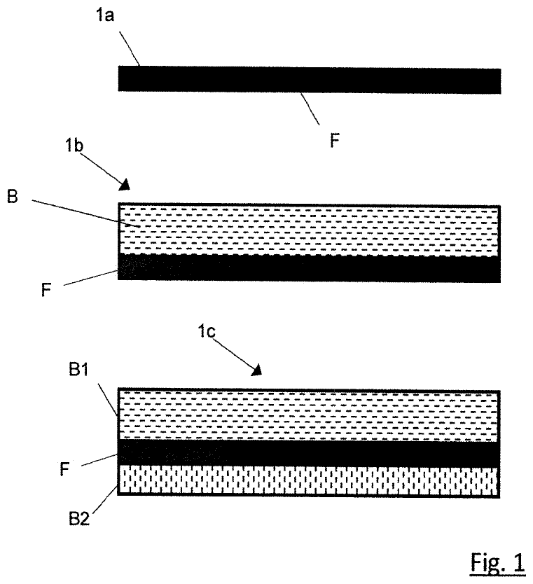

Different types of carriers 1a, 1b, 1c which can be processed or transported by means of a coating apparatus according to the present invention are schematically illustrated in FIG. 1. The carrier 1a essentially consists only of the foil F, without any coating. The carriers 1b, 1c each have one coating B or, respectively, two coatings B1, B2. The coatings B1, B2 can generally also differ from one another. Fundamentally suitable as coating B, B1, B2 is a paste or a dry coating. The further carriers 1 in the following figures can correspondingly be coated or uncoated.

FIG. 2 shows a detail of a transport path over which a foil F or a carrier 1 is transported in a transporting direction T in order to be coated. The carrier 1 runs over roller bearings 2. Furthermore, in order to orient particles in a coating of the foil of the carrier 1, magnets 3 (not illustrated here) are provided, in the magnetic field of which the particles can be oriented. In order to not disrupt the field lines, the magnets 3 are arranged between the roller bearings 2. The carrier 1 sags to some extent between two adjacent roller bearings 2, with the result that the distance of the carrier 1 from the magnet 3 decreases compared with a fully stretched foil. The roller bearings 2 have a small amount of friction, but also engage only on one side of the carrier 1 in this case. The foil side facing the magnet 3 is therefore the coated side, the opposite side, which is not contacted by the bearing, is coated. This arrangement has the disadvantage that the distance of the carrier 1 from the magnet 3, the distance being crucial for a defined particle orientation, depends very greatly on individual factors such as the current tensile stress on the carrier 1 and can by all means vary from case to case, as a result of which the manufacturing quality is subject to fluctuations.

The ground 4 is depicted in order to indicate the direction of gravitational force.

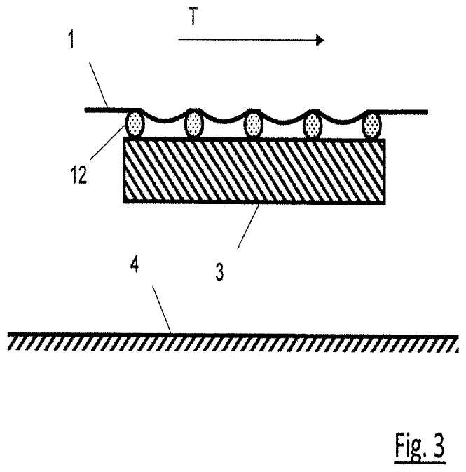

The sagging of the carrier 1 can be reduced by supporting the latter at more locations that lie closer together. However, a prerequisite for this is that the bearings 12 are smaller, in order to not significantly influence the magnetic field through the magnets 3. Such an embodiment can be achieved using grinding bearings in the form of spacers 12 as shown in FIG. 3. Individual wires or plastics threads, which are braced transverse to the transporting direction T and over which the carrier 1 can slide, are sufficient for the grinding bearings 12. The spacers 12 can then also lie between carrier 1 and magnet 3. Even if a certain degree of sagging of the carrier 1 can still be observed here, the distance of the carrier 1 from the magnet 3 is nevertheless approximately constant. During transport of the foil, the grinding bearings may scratch the surface of said foil as a result the friction.

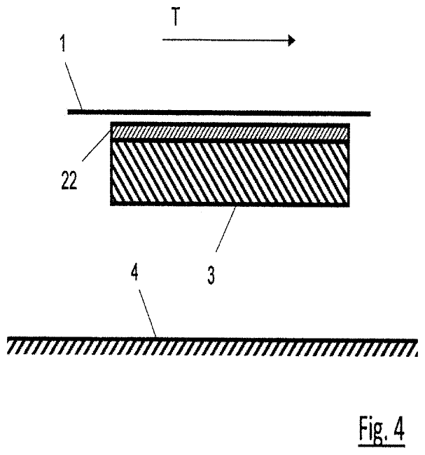

Friction effects can, by contrast, be reduced or avoided by way of air bearings 22, as is illustrated in FIG. 4. The mounting is in this case effected in a completely contactless manner.

According to FIGS. 2-4, one-sided mounting is provided. If the foil is deformed, for example, due to distortion during the drying of the applied coating paste, it can also detach locally from a bearing and lift off. This not only makes transport more difficult, but also the distance from the magnet 3 then no longer corresponds to the predetermined distance value, but rather has increased.

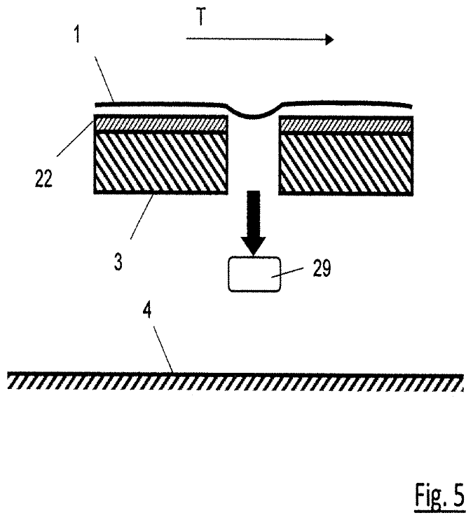

FIGS. 5-8 show bearings which act on two sides.

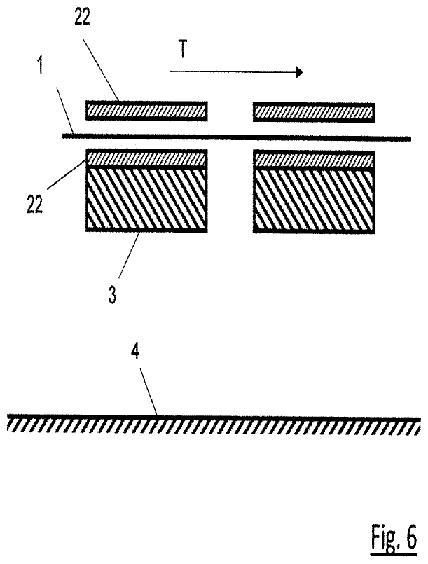

A contacting bearing such as a grinding or roller bearing could damage the coating on the foil top side. An air bearing in turn could, as shown in FIG. 6, block access to the upper, coated side, which could, for example, make the drying operation more difficult. In order to be able to allow a force which counteracts the supporting force of the bearing 22 to act on the carrier 1, a vacuum pump 29 in the form of a vacuum bearing which uses suction action to produce a pressing force against the air bearing 22 is provided in a preferred embodiment according to FIG. 4. In this case, the upper, coated side is freely accessible.

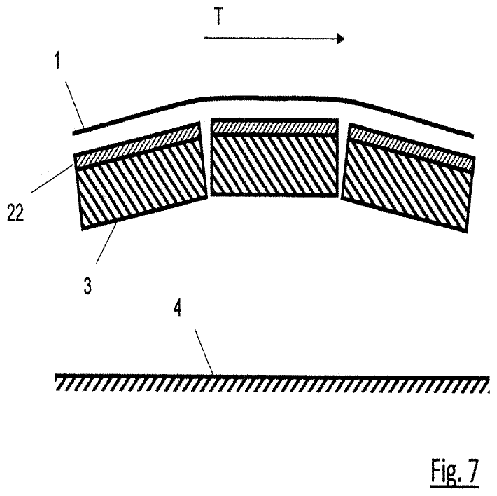

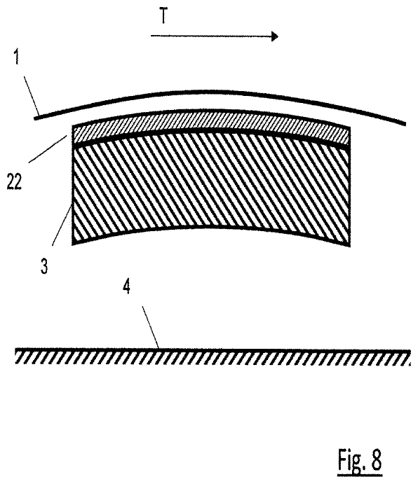

Another option having a two-sided mounting effect similar to in FIG. 5 (air bearing with vacuum bearing) can be achieved by exertion of a pulling force on the carrier 1. Corresponding embodiments with convex guide profile are illustrated in FIGS. 7 and 8. This pulling force is achieved by way of a convex guide profile, which is curved in relation to the transporting direction and away from the air bearings 22, because the carrier 1 in the stretched state has to exert a counterforce counter to the supporting force of the air bearings 22 in order to maintain the convex shape. In addition to the air bearings 22, the magnets 3 also have to be arranged angled relative to one another, as can be seen in FIG. 7, or the magnet is curved and thus generates the corresponding magnetic field with the desired field line profile or the desired field distribution, as is illustrated in FIG. 8. In general, the curvature cannot be selected to be as large as desired and the adaptation of the field line profile to the curvature is also not simple in technical terms, because a comparable field strength should fundamentally prevail at all points across a region of the carrier 1, in particular, transverse to the transporting direction. In the case of an angled magnet arrangement, as emerges from FIG. 7, the carrier 1 also runs in a slightly angled manner at the transition points between two magnets which are arranged angled relative to one another.

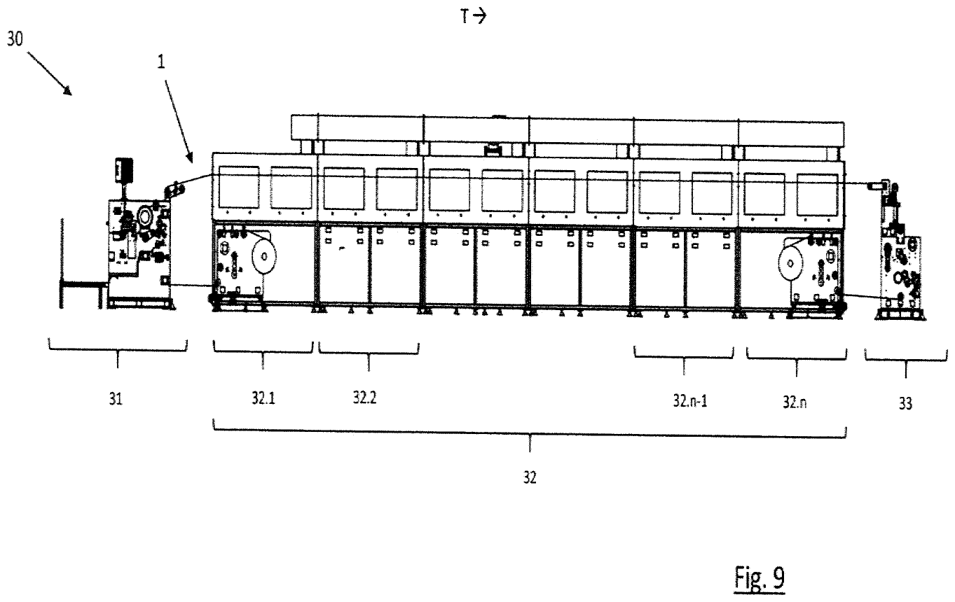

FIG. 9 shows a schematic illustration of a coating apparatus 30 for coating a foil F or a carrier 1. The foil F or the carrier 1 is provided with paste in the application station 31 and subsequently supplied in the transporting direction T to a drying module 32 for drying the paste. The drying module 32 comprises a determined number n of individual stations 32.1, 32.2, . . . , 32.n-1, 32.n, which are connected in series. By means of the return station 33, the carrier 1 returns with a reversal of direction, for example, in order to be coated on the other side.

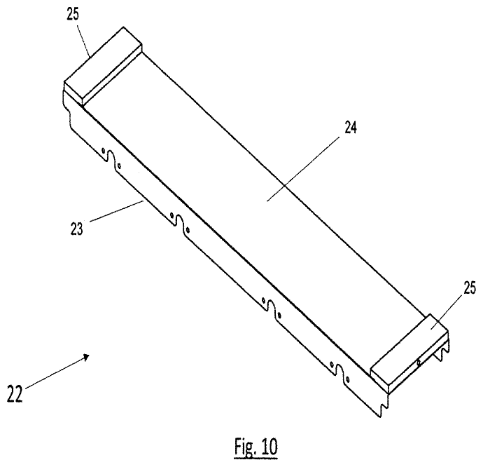

FIG. 10 shows the technical implementation of an air bearing 22 for a coating apparatus according to the present invention. The air bearing 22 comprises a fastening plate 23 in the form of a base plate for fitting within the installation. The surface 24 facing the object to be mounted is configured as a porous graphite surface, in order to be able to allow air to pass through and form an air cushion. To this end, air connections 25 are provided on the lateral sections.

### LIST OF REFERENCE DESIGNATIONS

1, 1a, 1b, 1c Carrier
2 Roller bearing
3 Magnet
4 Ground
12 Grinding bearing
22 Gas bearing/air bearing
23 Fastening plate
24 Porous graphite surface
25 Air connections
29 Vacuum pump/vacuum bearing
30 Coating apparatus
31 Application station
32 Drying module
32.1, 32.2, . . . ,32.n Individual stations for drying
33 Return station
B, B1, B2 Coating
F Foil
T Transporting direction

1. A coating apparatus for coating at least one side of a carrier with a coating comprising particles which can be oriented in a force field, comprising a transporting apparatus for transporting the carrier during the coating operation for coating the carrier on at least one side of the carrier, and also for transport at least after the application of the coating on one side, wherein an orienting apparatus for orienting particles in the coating is provided, said orienting apparatus generating a force field for orienting the particles, wherein the transporting apparatus comprises a bearing apparatus for the positionally stable mounting of the carrier in relation to the direction perpendicular to the transport surface, in which the carrier lies during transport, and/or perpendicular to the transporting direction, said bearing apparatus being configured to exert a mechanical force on the carrier and to engage at least with an uncoated side of the carrier and/or to form a mechanical constraint for the movement range of the carrier perpendicular to the surface and/or perpendicular to the transporting direction, at least in the direction of the uncoated side of the carrier, in order to counteract a change in position in relation to the direction perpendicular to the surface and/or perpendicular to the transporting direction.

2. The coating apparatus according to claim 1, wherein the bearing apparatus comprises:
at least one roller bearing, on which the carrier can rest and which is configured to, in contact with the carrier, co-rotate with the translational movement of the carrier, and/or
at least one grinding bearing, on which the carrier can rest and which is configured to, in contact with the carrier, remain rotationally fixed with respect to the translational movement of the carrier, and/or
at least one air bearing, for contactless mounting of the carrier, and/or
a vacuum bearing for exerting a pressing force perpendicular to the transport surface and/or transporting direction and/or for exerting a pulling force on the carrier parallel to the transporting direction, and/or
a liquid cushion as mount, and/or
an electromagnetic bearing.

3. The coating apparatus according to claim 1, wherein the bearing apparatus is configured for multi-side mounting of the carrier, which can be arranged on multiple sides of the carrier, wherein the bearing apparatus has at least two bearings situated opposite one another in relation to the transport surface and/or the carrier.

4. The coating apparatus according to claim 1, wherein the bearing apparatus comprises a contactless bearing, in order to engage with the uncoated and/or coated side of the carrier, said contactless bearing being configured as an air bearing.

5. The coating apparatus according to claim 1, wherein on a side of the transport surface on which the uncoated side of the carrier is located, at least two bearings are connected in series in the transporting direction and are arranged in an angled manner relative to one another, in order to permit a curved transport profile of the carrier.

6. The coating apparatus according to claim 1, wherein at least two air bearings, which are connected in series in the transporting direction are provided and a vacuum bearing is arranged between two successive gas bearings, in order to generate a pressing force perpendicular to the transporting direction.

7. The coating apparatus according to claim 2, wherein an opposite air bearing to the at least one air bearing is arranged in relation to the transport surface and/or to the carrier.

8. The coating apparatus according to claim 1, wherein the orienting apparatus is configured to generate a temporally and/or spatially alternating magnetic field using at least one permanent magnet, in order to orient the particles in the paste.

9. The coating apparatus according to claim 1, wherein the bearing apparatus is configured to hold the carrier at a distance of 0-200 mm away from the orienting apparatus.

10. The coating apparatus according to claim 1, wherein the bearing apparatus comprises at least two bearings which are connected in series in the transporting direction and the distance of which is between 1 cm and 8 m.

11. The coating apparatus according to claim 1, wherein the bearing apparatus is configured to guide the carrier on a curved transport path.

12. The coating apparatus according to claim 1, wherein the orienting apparatus has at least two partial orienting elements, which are connected in series in relation to the transporting direction and which are arranged in an angled manner relative to one another along at least a part of the curved transport path.

13. The coating apparatus according to claim 1, wherein the orienting apparatus is configured to be curved along at least a part of the curved transport path, in order to adapt the field distribution of the force field to the profile of the curved transport path.

14. The coating apparatus according to claim 1, wherein the carrier is a foil, and the coating is a paste and/or a dry coating for producing an anode of a lithium ion battery.

15. The coating apparatus according to claim 1, wherein the force field is a spatially and/or temporally alternating magnetic field.

16. The coating apparatus according to claim 2, wherein the grinding bearing is a wire and/or plastics thread which are/is arranged parallel to the transport surface and/or perpendicular to the transporting direction.

17. The coating apparatus according to claim 2, wherein the vacuum bearing is formed by a vacuum pump.

18. The coating apparatus according to claim 2, wherein the electromagnetic bearing is an electrostatic bearing and/or an eddy current bearing.

19. The coating apparatus according to claim 9, wherein the distance is 1 mm-4 mm.

20. The coating apparatus according to claim 10, wherein the distance is between 1 cm-50 cm.
